(19) United States
(12) Patent Application Publication
(10) Pub. No.: US 2026/0148618 A1
(43) Pub. Date: May 28, 2026

(54) Computational Card Game

(71) Applicant: Robert Samuel Simon, London (GB)

(72) Inventor: Robert Samuel Simon, London (GB)

(21) Appl. No.: 19/399,020

(22) Filed: Nov. 24, 2025

Related U.S. Application Data
(60) Provisional application No. 63/724,188, filed on Nov. 22, 2024.

(51) Int. Cl. G07F 17/32

(52) U.S. Cl. CPC G07F 17/3293; G07F 17/3262

(57) ABSTRACT

A computer-executed card game system facilitates a wagering game in which each player receives a hand containing both shared and unique cards while concealing which cards are common. A server distributes an initial hand including a first card, shared among all players, and a second card unique to each player, but each player's display shows only their hand without indicating which card is shared. Additional cards are then dealt so that each hand includes further shared and unique cards, again without revealing which are common. Wagers are collected into a community pool between dealing stages. This concealed shared-card structure produces asymmetric information, strategic uncertainty, and novel wagering dynamics distinct from conventional card games and outcome resolution rules for participating users

### FIELD OF THE INVENTION

The present invention relates generally to a card game. More specifically, the present invention is a card game executed computationally wherein information pertaining to the cards are selectively disclosed and undisclosed.

### BACKGROUND OF THE INVENTION

In the field of game theory, a game of incomplete information refers to a scenario where at least one participant possesses information that is not accessible to other participants. This type of game is also known as a Bayesian game. A fundamental characteristic of such games is the assumption that all players share a common knowledge prior regarding the distribution of information and use Bayesian inference to make decisions throughout the game. The process of Bayesian inference allows players to update their beliefs based on observed actions and available information, striving to maximize their expected utility given the uncertainty inherent in the game.

One of the earliest discussions of Bayesian games appeared in the 1944 work of Von Neumann and Morgenstern in their seminal book, Games and Economic Behavior. In this early analysis, they focused on a simplified model of poker, where two players receive independently random values between 0 and 1, with the higher value determining the winner in a showdown. The game includes wagering and folding, and their analysis demonstrated that bluffing is a fundamental strategy in optimal play, especially with weaker hands. This concept of bluffing being necessary in games of incomplete information was groundbreaking and provided a foundation for future studies of strategic behavior under uncertainty.

Further advancements in the analysis of Bayesian games have expanded on this initial framework. Specifically, two generalizations are highly relevant to the modern understanding of these games. First, in zero-sum Bayesian games, there are optimal strategies for all players, as demonstrated through Sion's Theorem (1958) and later formalized by Mertens, Sorin, and Zamir (1994). Second, if the distribution of information among players is independent, there is always an equilibrium, regardless of the number of players involved, as proven by Milgrom and Weber (1985).

For most game theorists, the concept of equilibrium in Bayesian games is closely tied to the notion of measurability. Strategies for the players are measurable if their values, corresponding to their behavior and different game outcomes, form a well-defined probability distribution. According to this perspective, for a strategy or outcome to be considered valid in a Bayesian game it must be measurable, meaning that its existence does not rely on some axiom of choice (necessary to construct a non-measurable set). This notion is essential in ensuring that players can apply their strategies in a predictable, describable, and rational manner. Most game theorists think that some equilibria in a Bayesian game should be measurable to maintain the integrity of strategic decision-making and expected payoffs for the players.

In 2003, a significant breakthrough in the study of Bayesian game equilibria occurred with the publication of a paper of the inventor that demonstrated a three-player Bayesian game such that all of its equilibria were not measurable, in other words that their existence was dependent on some axiom of choice. This finding revealed that in certain games, the nature of the players'information—defined by ergodic operators—can prevent equilibria from being measurable. Specifically, the sets known in common by the players were infinite, sparse in probability, and dense in the space of possibilities, and in equilibrium the players oriented themselves to these sets rather than the global structure of the game. These localized equilibria cannot be put together globally in a measurable way.

Building on this result, subsequent research has explored the limitations of equilibria in Bayesian games. Recent work by Grzegorz Tomkowicz and the inventor has shown that in certain two-player, non-zero-sum Bayesian games, there are equilibria but none that are measurable with respect to any finitely additive measure that respects the mutual beliefs of the players. This includes the non-existence of any such measurable epsilon-equilibrium where an epsilon-equilibrium comprises strategies that are epsilon approximately optimal for each player. This discovery has established a profound connection between Bayesian games and the Banach-Tarski paradox, a mathematical result concerning the counterintuitive behavior of sets and measures (when the dimension of the space is at least 3). The practical implication is that in these complex games, players may achieve either equilibrium or well-defined expected payoffs, but never both simultaneously.

Despite these theoretical advancements, translating such complex games into formats that can be played by individuals or computers presents a significant challenge. Most practical games must be finitely defined and, according to Nash's Theorem (1950), must possess equilibria (necessarily measurable). However, just as in cryptographic systems where breaking security is theoretically possible but infeasible in practice, some games may have solutions that are unattainable by human or computational means due to their complexity.

As mentioned above (Milgrom and Weber), informational independence is one way to ensure the existence of measurable equilibria. Indeed, Milgrom and Weber showed that some variations of informational independence are sufficient to prove the existence of measurable equilibria. It is more than just a theory. In the process of playing a game, independence (or near independence) is useful for obtaining an equilibrium. We return to the 1944 book of Von Neumann and Morgenstern, where two players receive independently random values between 0 and 1. The first player must consider what the second player knows, but what the second player knows is independent of what the first player knows. Independence allows for only a depth of 2 in the informational interaction, and that allows for manageable calculations. Most card games depart only a little from the independence assumption of Von Neumann and Morgenstern. However, the present invention uses the role of a computer to maximize the divergence from independence and force the players to consider further depths of informational interaction. A player is forced to think about how their information colors what other players know about their own information.

The radical departure from informational independence is accomplished by the main innovation, that the information given to a player is done by a neutral referee, a computer, who copies cards and distributes copies of the same card to different players without telling these players which cards are copied, and which are not. This innovation also makes the game impractical to play at home in the ways conventional card games are played.

In particular, the structure of the present invention requires that the game be executed on a computer system, or an equivalent electronic platform acting as a neutral referee. Because the same underlying card must be copied and distributed to multiple players while concealing which cards are shared and which are unique, it is not practically feasible to implement the game with a single physical deck using conventional dealing techniques. Any physical attempt to duplicate cards or manually track shared versus unique status would either reveal unintended information or demand an impractically complex and error-prone procedure. By contrast, a computer can maintain an internal representation of the deck, generate and manage multiple virtual copies of a single card, and control the information revealed to each player in a precise and consistent manner, thereby enabling the informational structure that characterizes the present invention.

To illustrate the problem, the present invention is compared to Texas Hold 'em. With two-player Texas Hold 'em, if I have the five of hearts and the jack of diamonds, aside from the eventual revelation of the common knowledge of the common cards, all I know about the hand of the other player at the start is that he or she does not have the five of hearts and does not have the jack of diamonds. In general, such information is not useful to me. Even in the rare situations when such information is useful, it would not be very useful. The possession of these two cards reduces the possibilities for the other player by about 4%. However, in the present invention, one's knowledge of one's hand removes around 799/800 of the possibilities for the hands of the other player. This forces the players to the strategic importance of informational interaction of depths three and beyond.

Given the increased informational depth and complexity of the present invention, even advanced computer algorithms may struggle to process all the potential outcomes. Poker games have proven difficult for computers to master due to the informational structure, and we created a game that increases that complexity intentionally. This could give an advantage back to human players when they possess strong, intuitive reasoning. The complexity and strategic demands of the present invention thus provide new challenges, both for human players and machines, where computational power may not guarantee success. The game introduces a new balance between intuition and calculation, potentially favoring the human player in head-to-head matches against the computer.

### BRIEF DESCRIPTION OF THE DRAWINGS

FIG. 1 is a schematic diagram of a networked card game system including a server and multiple user interface systems interconnected via a communication network.

FIG. 2 is a block diagram of an example user interface system illustrating a processor, memory storage, RAM, input/output interfaces, display, and input device.

FIG. 3 is a functional block diagram of a processor configured to establish and manage game sessions, allow players to join or start games, and manage player accounts and records.

FIG. 4 is a functional block diagram of a display subsystem configured to present the current state of the card game, show a player's initial hand, and render a shared turn card on a virtual table.

FIG. 5 is a schematic representation of evaluating each user's hand according to predetermined rules and determining outcomes such as winning, losing, or push results.

FIG. 6 is a block diagram illustrating volatile and non-volatile memory components used to maintain game state records, historical records, and atomic updates to game data during play.

FIG. 7 is a schematic diagram of a network component configured to transmit user-specific display payloads over a network connection while concealing which cards are shared or unique.

FIG. 8 is a diagram of example card layouts illustrating distributions of cards among players in accordance with the shared and unique card structure of the game.

FIG. 9 is a further diagram of example card layouts illustrating updated hands for multiple players including shared and unique cards after additional dealing.

FIG. 10 is a flow diagram of a card game method including maintaining rules and game state, receiving wagers, distributing initial and additional cards, updating displays, and dealing a shared turn card.

FIG. 11 is a schematic timeline diagram illustrating game actions from first through fifth wagers and the corresponding changes in what is displayed to the players.

FIG. 12 is a flowchart illustrating logic for determining whether a user has placed a wager and, if not, disabling input while maintaining display of the game state until a re-entry condition is met.

FIG. 13 is a series of display diagrams showing example screen states presented to users during second, third, fourth, and fifth wagering rounds, including growth of the displayed hands and shared card indicators.

FIG. 14 is a schematic diagram illustrating an unshuffled deck and a shuffled deck to represent shuffling the deck according to predetermined rules prior to card distribution.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of a computer executed card game system, embodiments of the present disclosure are not limited to use only in this context.

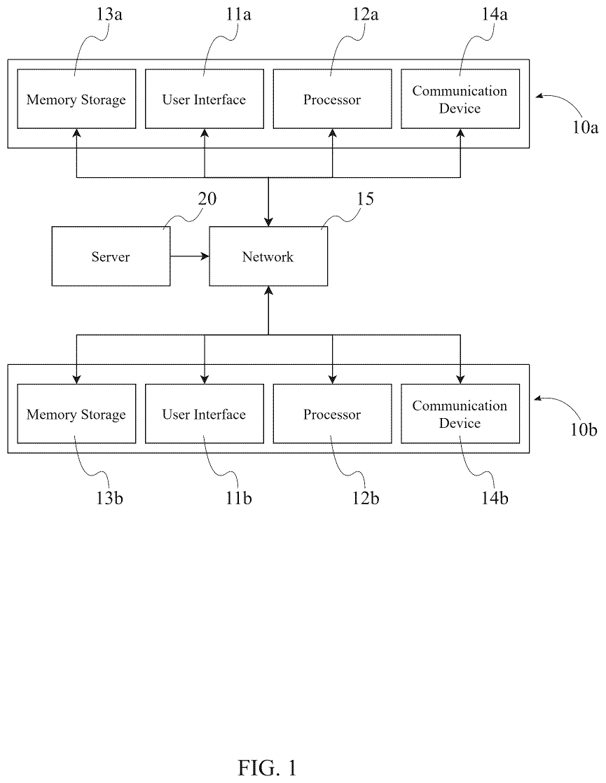

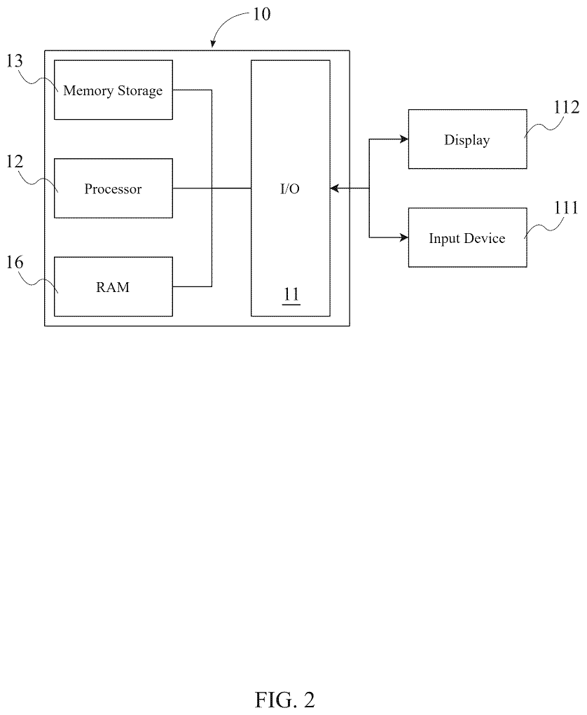

As shown in FIG. 1 and FIG. 2, the present invention is a computer executed card game system comprising a user interface system 11. In the context of the present invention, the user interface system 11 is a computational machine wherein a user communicates with the computer executed card game system through said user interface system 11. In the preferred embodiment of the present invention, the user interface system 11 comprises a processing unit 12 (shown as “Processor” in the drawings), a memory storage 13, a display 112, and a communication module 14 configured to establish a network connection 15 to a server 20. In the context of the present invention, the processing unit 12, further encapsulates 12a and 12b, wherein processing unit 12a and processing unit 12b are indicative of processing units belonging to different user computing devices. In the context of the present invention, the memory storage 13, further encapsulates 13a and 13b, wherein memory storage 13a and memory storage 13b are indicative of memory storages belonging to different user computing devices. Likewise, the communication module 14, in the context of the present invention, further encapsulates communication module 14a and communication module 14b wherein communication module 14a and communication module 14b are indicative of differing communication modules of differing user computing devices. The user interface system 11 further comprises a random access memory (RAM) 16 configured to temporarily store card game 31 state data and computer-executable instructions while the processing unit 12 executes the card game 31 according to the predetermined set of rules.

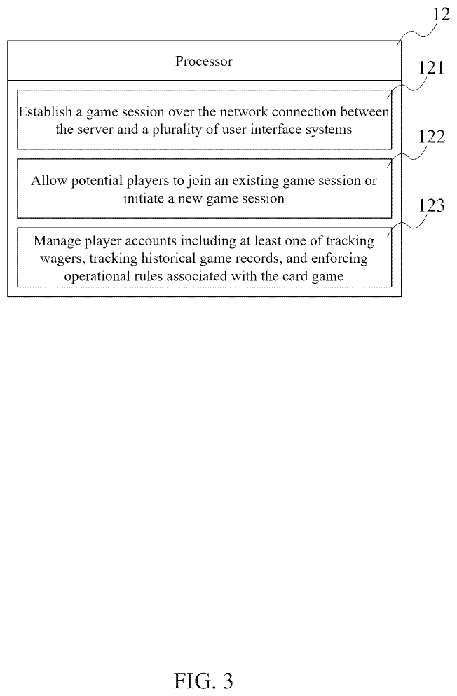

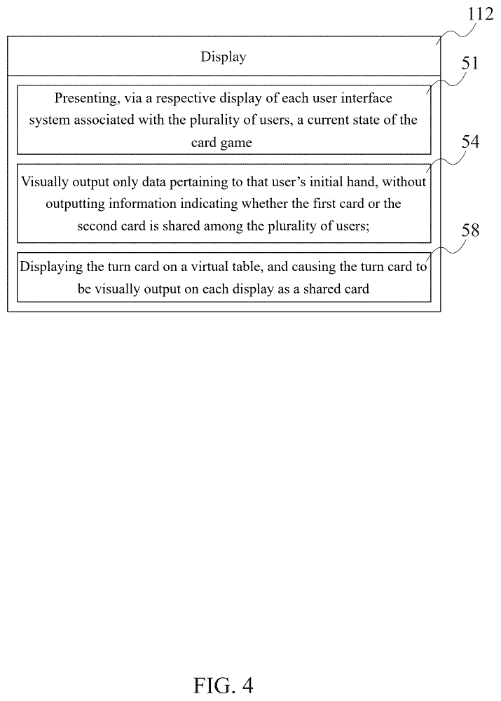

As shown in FIG. 3, In the context of the present invention, the processing unit 12 is a computational unit wherein said processing unit 12 executes computer readable instructions and algorithms within the card game system. The processing unit 12 manages the flow of data, processes game logic, evaluates conditions and facilitates processes including shuffling, drawing, resolving card actions, receiving wagers, and determines outcomes based on predefined rules. Further, the processing unit 12 is configured to execute the computer-executable instructions to facilitate user interaction by outputting, via the display, as shown in FIG. 4, information defining a current state of the card game 31 and receiving user inputs from a user associated with the at least one user interface system 11. Furthermore, the processing unit 12 coordinates processes and communicates information within the computer executed card game system. Furthermore, the processing unit 12 is configured to establish 121 a game session over the network connection 15 between the server 20 and a plurality of user interface systems 11a,11b. Additionally, the processing unit 12 allows 122 potential users to join an existing game session and initiate a new game session. In some embodiments, the processing unit 12 is further configured to manage 123 player accounts including at least one of: tracking wagers, tracking historical game records, and enforcing operational rules associated with the card game 31 disclosed herein.

In some embodiments, the computer-executable instructions are stored on a non-transitory, machine-readable medium. When executed by at least one computing device 10, the instructions cause the computing device 10 to perform operations comprising facilitating a card game 31 for a plurality of users according to a predetermined set of rules, the card game 31 comprising at least one wager 32, a deck 33 comprising a plurality of cards 333, a plurality of hands 34, and a table 35; presenting 51, via a plurality of displays respectively associated with the plurality of users, a current state of the card game 31 including at least one of visual representations of cards 333, hands, and the table 35; receiving, from a first user of the plurality of users, a first wager 321 comprising a unit of value greater than or equal to zero; distributing 53, from the deck 33, a plurality of cards 333 comprising a first card 3331 and a second card 3332 to each of the plurality of users to form an initial hand for each respective user, wherein the first card 3331 assigned to each of the plurality of users has equivalent attributes and the second card 3332 assigned to each of the plurality of users is unique to that respective user; and causing 54 each display 112 associated with a respective user to visually output only data and information pertaining to the hand of that respective user, such that information pertaining the first card 3331 and the second card 3332 is displayed in a manner that is indistinguishable as to which of the first card 3331 and the second card 3332 is shared amongst the plurality of users. In the context of the present invention, the first card 3331 further encapsulates first card 3331a and first card 3331b wherein said first card 3331a and first card 3331b are indicative of the first card 3331a of a first user 10a and a first card 3331b of a second user 10b wherein the first card 3331a of the first user 10a and the first card 3331b of the second user 10b are different from each other.

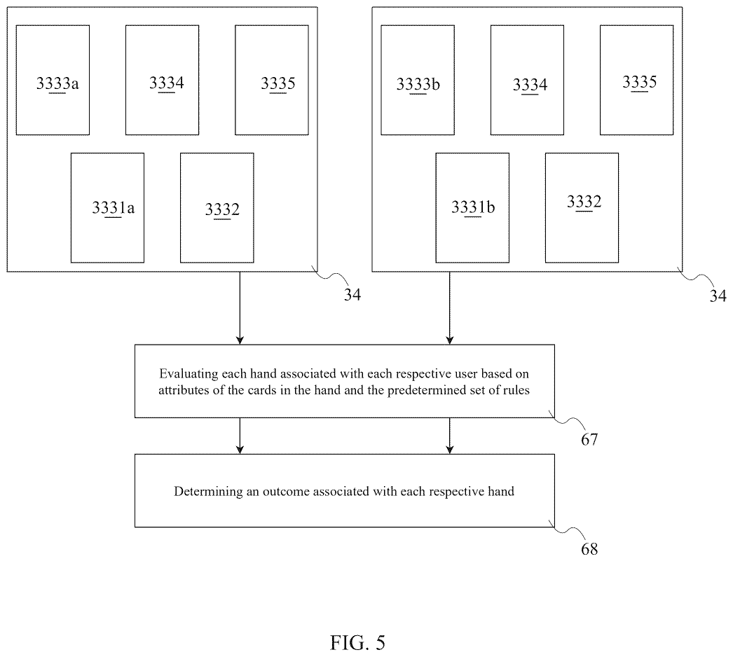

In some embodiments, the operations further comprise shuffling 66 the deck 33 comprising the plurality of cards 333 according to the predetermined set of rules prior to distributing the first card 3331 and the second card 3332, evaluating 67 each hand associated with each respective user based on attributes of the cards in the hand and the predetermined set of rules, and determining 68 an outcome associated with each respective hand, as shown in FIG. 5. In some embodiments, the operations further comprise establishing 121, via a communication module 14, a game session between a server 20 and a plurality of user interface systems 11a,11b respectively associated with the plurality of users. In some embodiments, the operations further comprise retrieving the predetermined set of rules from a memory storage 13 device.

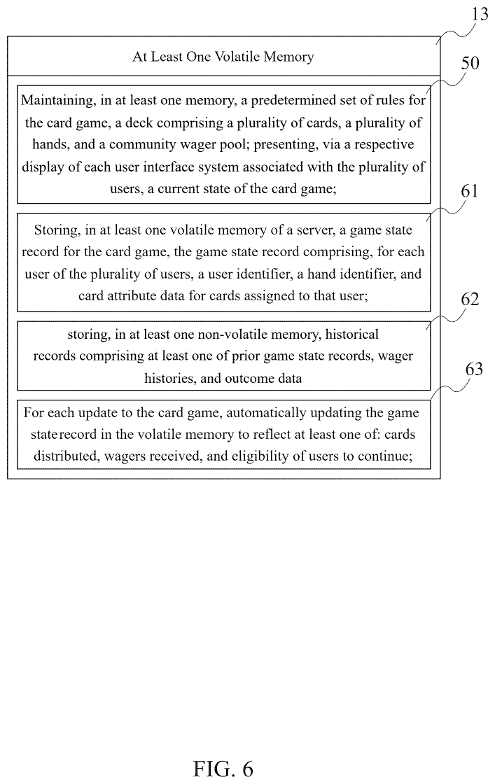

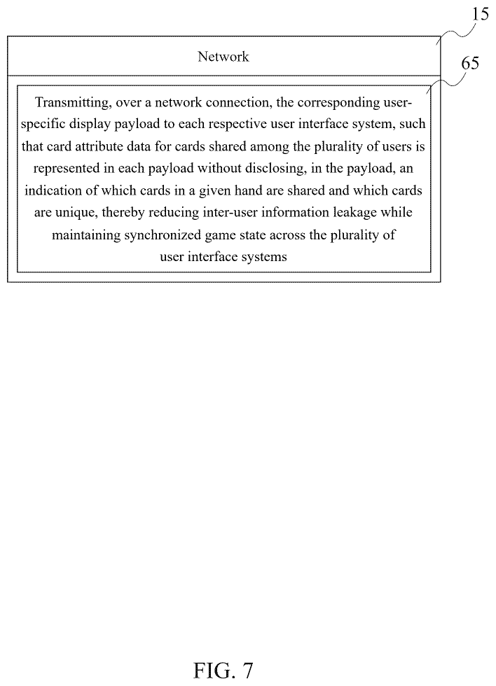

Furthermore, the memory storage 13 stores game-related data. In some embodiments, the memory storage 13 stores computer-executable instructions and game-related data including a predetermined set of rules for a card game 31 comprising at least one wager 32, a deck 33 comprising a plurality of cards 333, a plurality of hands 34, and a table, and data defining the at least one wager 32, the plurality of cards 333, the plurality of hands 34, and a community wager pool. The memory storage 13, as shown in FIG. 6, retains both temporary (volatile) data for ongoing operations and permanent (non-volatile) data such as historical records, game settings, and operational rules. In some embodiments, the system further stores, in at least one volatile memory of a server 20, a game state record for the card game 31, the game state record comprising, for each user of the plurality of users, a user identifier, a hand identifier, and card attribute data for cards assigned to that user, and stores, in at least one non-volatile memory, historical records comprising at least one of prior game state records, wager histories, and outcome data. For each update to the card game 31, the processing unit 12 automatically updates 63 the game state record in the volatile memory to reflect at least one of: cards distributed, wagers received, and eligibility of users to continue. As shown in FIG. 7, the processing unit 12 generates 64, for each user interface system 11, a user-specific display 112 payload by filtering the game state record to include only the card attribute data and wager information associated with that user, and transmits 65, over a network connection 15, the corresponding user-specific display 112 payload to each respective user interface system 11. In some embodiments, card attribute data for cards shared among the plurality of users is represented in each payload without disclosing, in the payload, an indication of which cards in a given hand are shared and which cards are unique, thereby reducing inter-user information leakage while maintaining synchronized game state across the plurality of user interface systems 11a,11b.

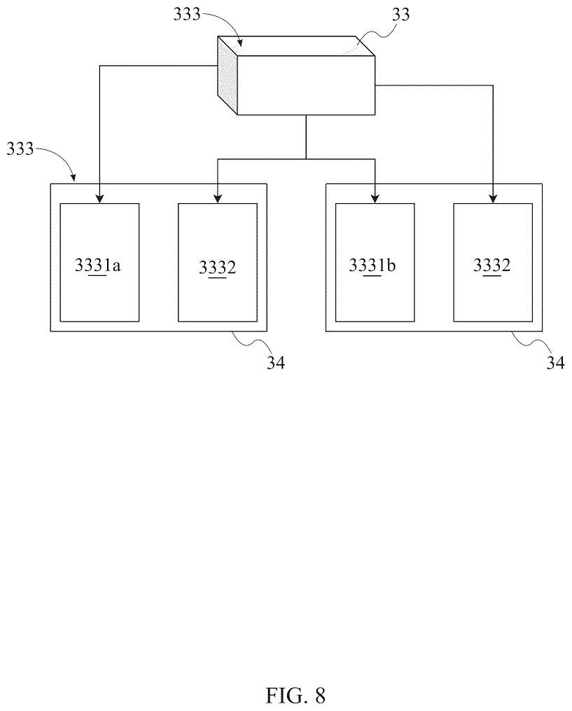

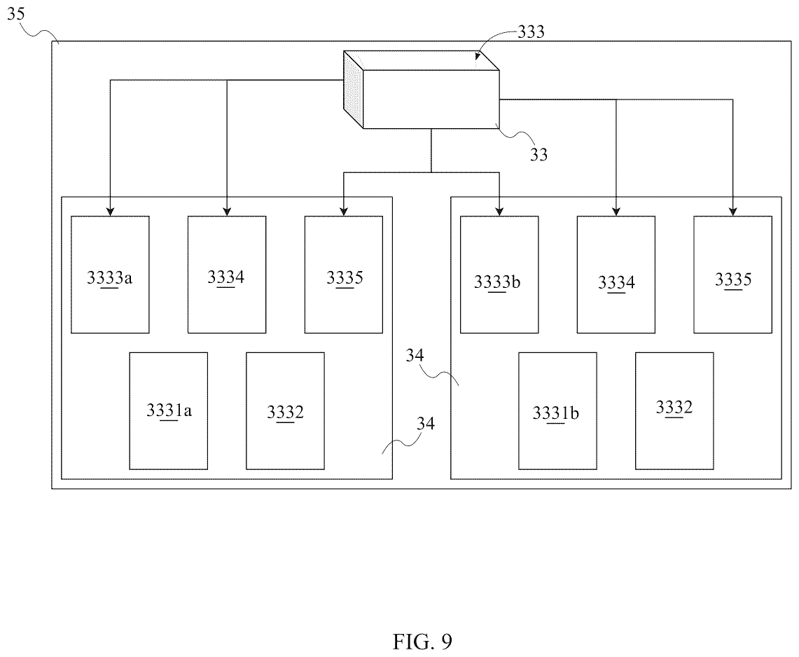

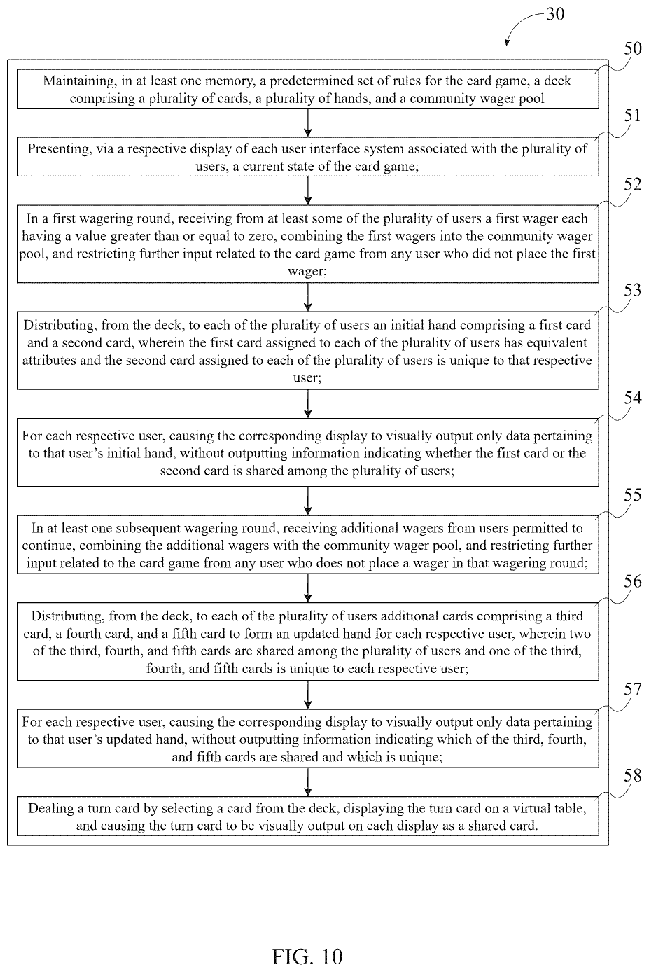

As shown in FIG. 8, FIG. 9, and FIG. 10, in some embodiments, the present invention comprises maintaining 50, in at least one memory, a predetermined set of rules for the card game 31, a deck 33 comprising a plurality of cards 333, a plurality of hands 34, and a community wager pool. Further, in some embodiments, the present invention comprises storing 61, in at least one volatile memory of a server 20, a game state record for the card game 31, the game state record comprising, for each user of the plurality of users, a user identifier, a hand identifier, and card attribute data for cards assigned to that user and storing 62, in at least one non-volatile memory, historical records comprising at least one of prior game state records, wager histories, and outcome data.

In addition, the communication module 14, network connection 15, and processing unit 12, in the context of the present invention, allow 122 potential players to establish or participate in previously established games, as well as support player account management. Moreover, within the context of the present invention, the display 112 is a visual output interface that renders the current state of the game system for users, including visual representations of cards, hands, tables, and system-generated information. The display 112 translates internal data into a graphical format, providing real-time updates and visual feedback based on system operations and game progress. Furthermore, in some embodiments of the present invention, the display 112 facilitates and receives a user input through an input device 111.

As shown in FIG. 1 and FIG. 2, in the context of the present invention, the communication module 14 facilitates data exchange between the card game system and external entities including establishing the network connection 15 to the server 20. The communication module 14 and the processing unit 12 are further configured to establish 12 a game session over the network connection 15 between the server 20 and a plurality of user interface systems 11a,11b.

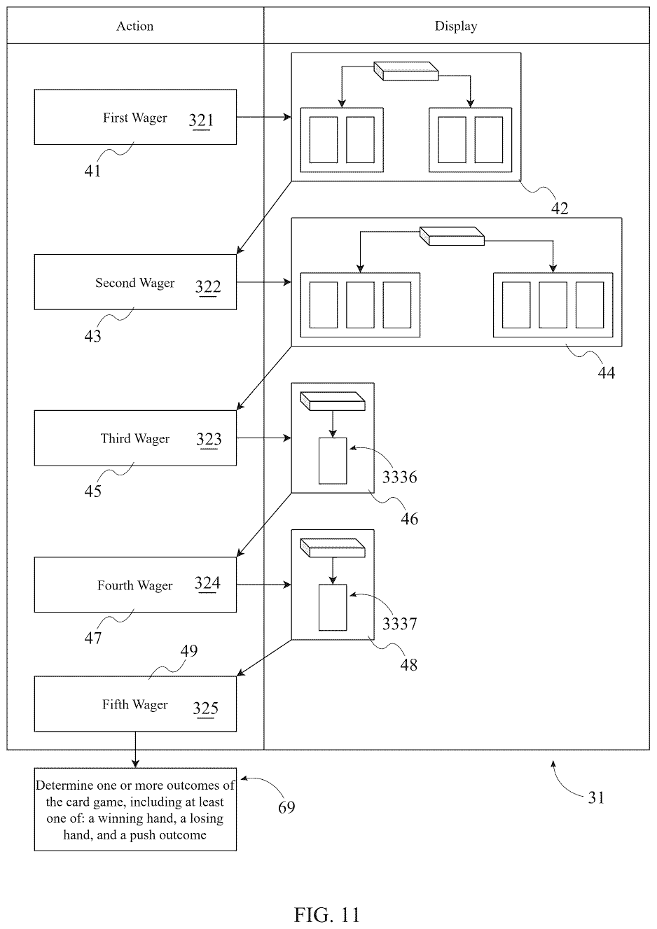

In the preferred embodiment of the present invention, as shown in FIG. 10 and FIG. 11, the processing unit 12 executes a computer executable method 30 abiding by a predetermined set of rules wherein the display 112 outputs information to the user and receives inputs from said user, according to said set of rules, facilitating a card game 31. In the preferred embodiment of the present invention, the card game 31 comprises at least one wager 32, a deck 33 comprising a plurality of cards 333, a plurality of hands 34, and a table. In the context of the present invention, the wager is a unit of value, currency, or resources greater than or equal to 0, that is received or processed by the system in response to a triggering condition or event. The system may store, adjust, or transfer the wager according the predefined set of rules and conditions. Further, within the context of the present invention, the deck 33 is a collection of discrete elements or units stored within the system, arranged in a predefined order or randomized configuration. The system may manipulate the deck 33 by adding, removing, or reorganizing elements based on operational requirements. In the context of the present invention, the elements, as previously mentioned, refer to cards. Moreover, cards, as disclosed herein are Individual elements or units within a deck 33, each encoded with specific attributes, values, or properties. The system processes each card according to its attributes and predefined rules to generate outcomes, responses, or actions. As referred to herein, the hand is a subset of cards or units drawn or selected from a collection, such as a deck 33, which are assigned or processed by the system, attributed to each of the users. The system organizes and evaluates 67 the hand according to specific rules or algorithms to determine further actions or outputs. Lastly, the table, as referred to herein, is a virtual environment within the system where multiple operations, actions, or interactions involving elements (such as cards or wagers) occur. The system regulates the table environment according to specified conditions and may display, modify, or calculate outcomes based on the elements present.

As shown in FIG. 10 and FIG. 11, in an embodiment, a card game 31 method for facilitating game play via a computing device 10 comprises: maintaining 50, in at least one memory, a predetermined set of rules for the card game 31, a deck 33 comprising a plurality of cards 333, a plurality of hands 34, and a community wager pool; presenting 51, via a respective display 112 of each user interface system 11 associated with the plurality of users, a current state of the card game 31; in a first wagering round, receiving 52 from at least some of the plurality of users a first wager 321 each having a value greater than or equal to zero, combining the first wagers into the community wager pool, and restricting further input related to the card game 31 from any user who did not place the first wager 321; distributing 53, from the deck 33, to each of the plurality of users an initial hand comprising a first card 3331 and a second card 3332, wherein the first card 3331 assigned to each of the plurality of users has equivalent attributes and the second card 3332 assigned to each of the plurality of users is unique to that respective user; for each respective user, causing 54 the corresponding display 112 to visually output only data pertaining to that user's initial hand, without outputting information indicating whether the first card 3331 or the second card 3332 is shared among the plurality of users; in at least one subsequent wagering round, receiving 55 additional wagers from users permitted to continue, combining the additional wagers with the community wager pool, and restricting further input related to the card game 31 from any user who does not place a wager in that wagering round; distributing 56, from the deck 33, to each of the plurality of users additional cards comprising a third card 3333, a fourth card 3334, and a fifth card 3335 to form an updated hand for each respective user, wherein two of the third card 3333, the fourth card 3334, and the fifth card 3335 are shared among the plurality of users and one of the third card 3333, the fourth card 3334, and the fifth card 3335 is unique to each respective user; for each respective user, causing 54 the corresponding display 112 to visually output 57 only data pertaining to that user's updated hand, without outputting information indicating which of the third card 3333, the fourth card 3334, and the fifth card 3335 are shared and which is unique; and dealing 58 a turn card 3336 by selecting a card from the deck 33, displaying the turn card 3336 on a virtual table 35, and causing the turn card 3336 to be visually output on each display 112 as a shared card.

As shown in FIG. 10 and FIG. 11, in the preferred embodiment of the present invention, the game and the computer executable method 30 comprises a plurality of steps wherein said plurality of steps are executed by the system to a plurality of users. In the preferred embodiment of the present invention, the plurality of steps comprises a first step 41 wherein a first wager 321 is received 52 by the system, from the user wherein said first wager 321 comprises a unit of value greater than or equal to zero. In the preferred embodiment of the present invention, by receiving the wager, the system outputs information to the user in which the wager was received by, indicating that the user is eligible to continue to provide inputs to the system and the system will continue to receive inputs from said user. In response to receipt of the first wager 321, the system generates an output on the display 112 indicating that the user is eligible to continue providing inputs to the system, while ceasing to accept further input from any user from whom the first wager 321 is not received until a future iteration of the computer-executable method. In the first step 41, each wager received is combined to compose a community wager pool.

As shown in FIG. 10 and FIG. 11, in the preferred embodiment of the present invention, the plurality of steps further comprises a second step 42 wherein a plurality of cards 333, comprising a first card 3331 and a second card 3332, are distributed 53 to each of a plurality of users to form a first hand for each respective user, the plurality of cards 333 for each user comprising a first card 3331 having attributes that are equivalent across the plurality of users, and a second card 3332 that is unique to each respective user. In the preferred embodiment of the present invention, the first card 3331 of each hand comprises equivalent attributes (i.e. the same card) whereby the second card 3332 of each hand is unique to each respective user; both of which are outputted to each respective player through the respective display. In the context of the present invention, each display 112 only visually outputs data and information pertaining to the hand of the respective player. In the context of the present invention, the system does not output information pertaining to one card belonging uniquely to a user or communally to all users. Furthermore, the display 112 does not output information disclosing which of the first card 3331 and second card 3332 is shared amongst the plurality of users. From the perspective of each user, only their hand is known, and the card of that hand that is shared is unknown. In the preferred embodiment of the present invention, the computer executable method 30 duplicates, distributes, and outputs the data and attributes pertaining to the shared card to each display.

As shown in FIG. 10 and FIG. 11, in the preferred embodiment of the present invention, the plurality of steps further comprises a third step 43 wherein a second wager 322 is received by the card game system, from the computational machine associated with the users that possess a hand. By receiving the wager, the system outputs information to the user in which the wager was received by, indicating that the user is eligible to continue to provide inputs to the system and the system will continue to receive inputs from said user. In the event that a wager is not received by the system from an input made by the user, the system will cease to accept further input until a future iteration of the computer executable method 30. In the third step 43, each wager received is combined to further contribute to the community wager pool.

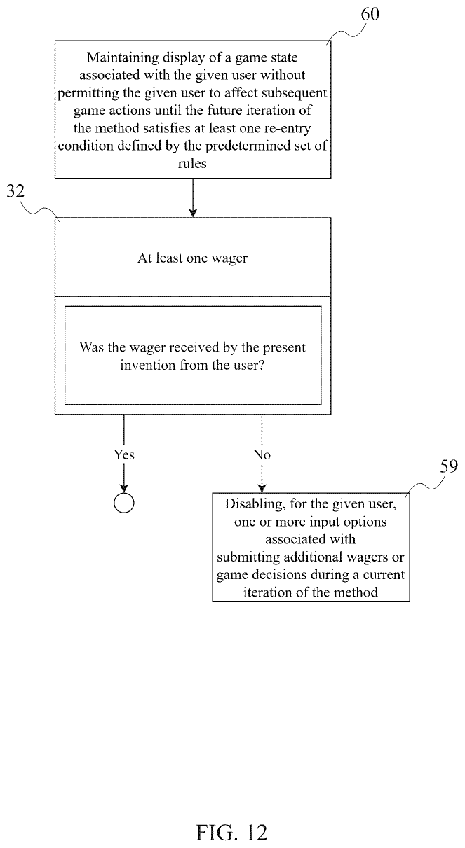

As shown in FIG. 12, in some embodiments, restricting further input for a given user comprises disabling 59, for the given user, one or more input options associated with submitting additional wagers or game decisions during a current iteration of the method, and maintaining display 112 of a game state associated with the given user without permitting the given user to affect subsequent game actions until a future iteration of the method satisfies at least one re-entry condition defined by the predetermined set of rules.

As shown in FIG. 10 and FIG. 11, in some embodiments, the operations further comprise receiving a second wager 322 wherein in response to receiving the second wager 322 from a given user, the at least one computing device 10 further outputs, via the display 112 associated with the given user, an indication that the respective user is eligible to continue to provide inputs to the computing device 10. Furthermore, in the preferred embodiment, the second wager 322 is combined with the community wager pool. Further, following the receipt of the second wager 322, the at least one computing device 10 further performs operations comprising ceasing to accept further input from any user from whom the second wager 322 is not received until a future iteration of the card game 31.

As shown in FIG. 10 and FIG. 11, in the preferred embodiment of the present invention, the plurality of steps further comprises a fourth step 44 comprising distributing 56 additional cards from the deck 33 to each user to form an updated hand comprising a third card 3333, a fourth card 3334, and a fifth card 3335, wherein two cards selected from the third card 3333, the fourth card 3334, and the fifth card 3335 are shared among the plurality of users and one card selected from the third card 3333, the fourth card 3334, and fifth card 3335 is unique to each respective user, and the display 112 of each user interface system 11 visually outputs only data and information pertaining to the updated hand of the respective user, suppressing information indicating which cards are shared and which card is unique. In the context of the present invention, two of the cards selected from the third card 3333, the fourth card 3334, and the fifth card 3335 are shared by each hand. In the context of the present invention, one of the cards selected from the third card 3333, the fourth card 3334, and the fifth card 3335, is unique to each user. Similarly, to the second step 42, in the fourth step 44, each display 112 only visually outputs data and cause the display 112 of each user interface system 11 to visually output only data and information pertaining to the hand of the respective user, such that information pertaining the first card 3331 and the second card 3332 is displayed in a manner that is indistinguishable as to which of the first card 3331 and the second card 3332 is shared amongst the plurality of users.

As shown in FIG. 10 and FIG. 11, in some embodiments, the operations further comprise dealing a third card 3333, a fourth card 3334, and a fifth card 3335 wherein the plurality of cards 333 further comprises a third card 3333, a fourth card 3334, and a fifth card 3335, wherein two cards selected from the third card 3333, the fourth card 3334, and the fifth card 3335 are shared among the plurality of users such that one card selected from the third card 3333, the fourth card 3334, and fifth card 3335 is unique to each respective user. Further, in the preferred embodiment, the display 112 of each user interface system 11 visually outputs only data and information pertaining to an updated hand of the respective user, suppressing information indicating which cards are shared amongst the plurality of users and which card is unique to each respective user.

As shown in FIG. 10 and FIG. 11, in the preferred embodiment of the present invention, the plurality of steps further comprises a fifth step 45 comprising receiving a third wager 323 from the plurality of users possessing the updated hand; combining each received third wager 323; outputting, via the display, an indication that a user from whom the third wager 323 is received is eligible to continue providing inputs to the system; and ceasing accepting further input from any user from whom the third wager 323 is not received until a future iteration of the computer-executable method. By receiving the wager, the system outputs information to the user in which the wager was received by, indicating that the user is eligible to continue to provide inputs to the system and the system will continue to receive inputs from said user. In the event that a wager is not received by the system from an input made by the user, the system will cease to accept further input until a future iteration of the computer executable method 30. In the fifth step 45, each wager received is combined to further contribute to the community wager pool.

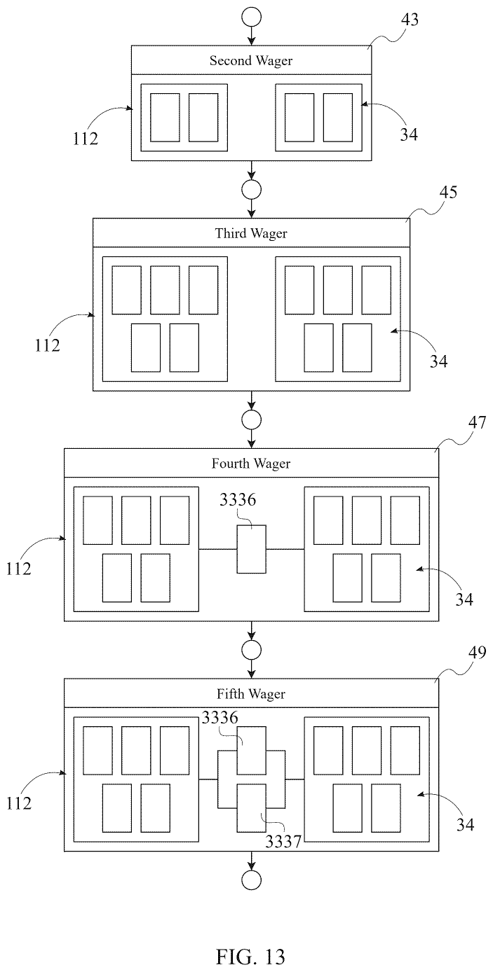

As shown in FIG. 10 and FIG. 11, in the preferred embodiment of the present invention, the plurality of steps further comprising a sixth step 46 of dealing 58 a turn card 3336 to the table 35 by selecting an additional card from the deck 33 and causing 54 the turn card 3336 to be visually displayed, via the display, as a shared card to each user interface system. As shown in FIG. 13, in the context of the present invention, a “turn” card is a card played on the table 35, visually displayed to each computational machine through the display, wherein said “turn” card is indicated by the card game system as being a shared card.

As shown in FIG. 10 and FIG. 11, in the preferred embodiment, the plurality of steps further comprises a seventh step 47, after the turn card 3336 is displayed, comprising receiving a fourth wager 324 from the plurality of users possessing the updated hand; combining each received third wager 323; outputting, via the display, an indication that a user from whom the fourth wager 324 is received is eligible to continue providing inputs to the system; and ceasing accepting further input from any user from whom the fourth wager 324 is not received until a future iteration of the computer-executable method. In the event that a wager is not received by the system from an input made by the user, the system will cease to accept further input until a future iteration of the computer executable method 30. In the seventh step 47, each wager received is combined to further contribute to the community wager pool.

Furthermore, as shown in FIG. 10 and FIG. 11, in the preferred embodiment of the present invention, the plurality of steps further comprises an eighth step 48 wherein a “river” card 3337 is dealt, as further shown in FIG. 13. In the context of the present invention, the “river” card 3337 is played on the table 35 and visually displayed to each computational machine through the display, wherein said “river” card 3337 is indicated by the card game system as being a shared card.

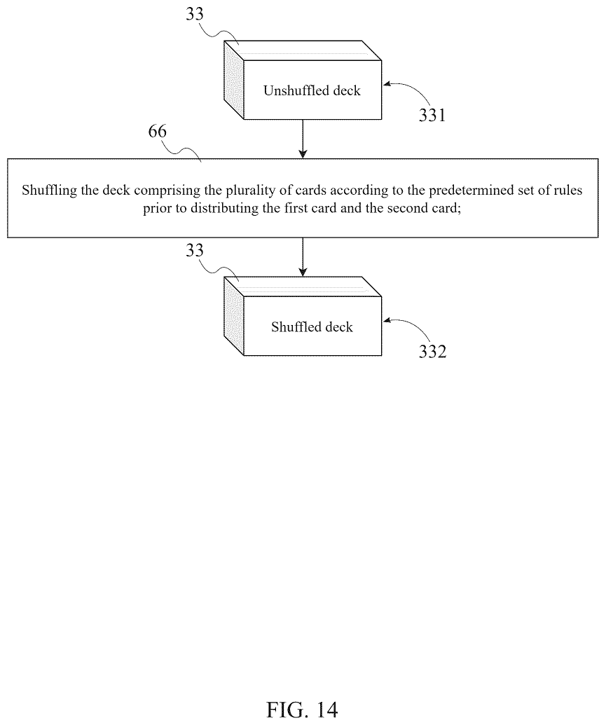

In some embodiments, as shown in FIG. 14, the processing unit 12 is further configured to shuffle 66 the deck 33 comprising the plurality of cards 333 according to a predetermined set of rules prior to distributing cards to the plurality of users, evaluate 67 each hand associated with each respective user based on attributes of the cards in the hand and the predetermined set of rules, and determine at least one outcome of the card game 31, including at least one of: a winning hand, a losing hand, and a push outcome. In the context of the present invention, shuffling 66, the deck 33 transforms the deck 33 from an unshuffled 331 deck 33 to a shuffled 332 deck 33.

Lastly, as shown in FIG. 10 and FIG. 11, in the preferred embodiment of the present invention, the plurality of steps further comprises a ninth step 49 wherein a fifth wager 325 is received by the card game system, from the computational machine associated with the users that possess a hand. Upon receiving the fifth wager 325, the card game system, through the processing unit 12, evaluates 67 each hand according to the predetermined set of rules to determine which user of the plurality of users will be awarded the community pool. The computational machine associated with the awarded user will output data indicative of the awarded community pool. In the preferred embodiment of the present invention, player accounts will be modified based upon the result of this step to reflect wagers made by players in the game. After outputting such data, the computer executable method 30 reiterates beginning with the first step 41. The card game 31 method may further comprise shuffling 66 the deck 33 comprising the plurality of cards 333 according to the predetermined set of rules prior to distributing the first card 3331 and the second card 3332, evaluating 67, by at least one processing unit 12, each hand associated with each respective user based on attributes of the cards in the hand and the predetermined set of rules, and determining 69 at least one outcome of the card game 31, including at least one of: a winning hand, a losing hand, and a push outcome, based on the evaluation.

Although the invention has been explained in relation to its preferred embodiment, it is to be understood that many other possible modifications and variations can be made without departing from the spirit and scope of the invention.

What is claimed is:

1. A card game system, comprising:
at least one user interface system comprising:
a processing unit;
a memory storage;
a display; and
a communication module configured to establish a network connection to a server;
the memory storage storing computer-executable instructions and game-related data including:
a predetermined set of rules for a card game comprising at least one wager, a deck comprising a plurality of cards, a plurality of hands, and a table; and
data defining wagers, cards, hands, and a community wager pool;
wherein the processing unit is configured to execute computer-executable instructions to:
facilitate user interaction by outputting, via the display, information defining a current state of the card game and receiving user inputs from a user associated with the at least one user interface system;
receive a first wager from the user, the first wager comprising a unit of value greater than or equal to zero, and, in response to receipt of the first wager, generate an output on the display, indicating that the user is eligible to continue providing inputs to the system; and
in response to receipt of the first wager, distribute, from the deck, a plurality of cards to each of a plurality of users to form a first hand for each respective user, the plurality of cards for each user comprising:
a first card having attributes that are equivalent across the plurality of users; and
a second card that is unique to each respective user;
cause the display of each user interface system to visually output only data and information pertaining to the hand of the respective user, such that information pertaining the first card and the second card is displayed in a manner that is indistinguishable as to which of the first card and the second card is shared amongst the plurality of users.

2. The card game system, as claimed in claim 1, wherein:
the processing unit is further configured to distribute additional cards from the deck to each user to form an updated hand comprising a third card, a fourth card, and a fifth card, wherein:
two cards selected from the third, fourth, and fifth cards are shared among the plurality of users;
one card selected from the third card, the fourth card, and fifth card is unique to each respective user; and
the display of each user interface system visually outputs only data and information pertaining to the updated hand of the respective user, suppressing information indicating which cards are shared and which card is unique.

3. The card game system, as claimed in claim 2, wherein:
the processor is further configured to:
receive a third wager from users possessing the updated hand;
combine each received third wager; and
cease accepting further input from any user from whom the third wager is not received until a future iteration of the computer-executable instructions.

4. The card game system, as claimed in claim 3, wherein the display outputs an indication that a user from whom the third wager is received is eligible to continue providing inputs to the system.

5. The card game system, as claimed in claim 3, wherein, the processor is further configured to deal a turn card to the table by selecting an additional card from the deck and causing the turn card to be visually displayed, via the display, as a shared card to each user interface system.

6. The card game system, as claimed in claim 5, wherein the processing unit is further configured to a fourth wager from users possessing a hand after the turn card is displayed.

7. The card game system, as claimed in claim 6 wherein the processing unit is further configured to:
output, via the display, an indication that a user from whom the fourth wager is received is eligible to continue providing inputs to the system;
combine each received fourth wager; and
cease accepting further input from any user from whom the fourth wager is not received until a future iteration of the computer-executable method.

8. The card game system of claim 1, wherein the processing unit is further configured to:
shuffle the deck comprising the plurality of cards according to a predetermined set of rules prior to distributing cards to the plurality of users;
evaluate each hand associated with each respective user based on attributes of the cards in the hand and the predetermined set of rules; and
determine at least one outcome of the card game, including at least one of:
a winning hand, a losing hand, and a push outcome.

9. The card game system of claim 1, wherein the communication module and the processing unit are further configured to:
establish a game session over the network connection between the server and a plurality of user interface systems.

10. A non-transitory, machine-readable medium storing computer program instructions operable to cause at least one computing device to perform operations comprising:
facilitating a card game for a plurality of users according to a predetermined set of rules, the card game comprising at least one wager, a deck comprising a plurality of cards, a plurality of hands, and a table;
presenting, via a plurality of displays respectively associated with the plurality of users, a current state of the card game including at least one of visual representations of cards, hands, and the table;
receiving, from a first user of the plurality of users, a first wager comprising a unit of value greater than or equal to zero;
distributing, from the deck, a plurality of cards comprising a first card and a second card to each of the plurality of users to form an initial hand for each respective user, wherein:
the first card assigned to each of the plurality of users has equivalent attributes; and
the second card assigned to each of the plurality of users is unique to that respective user; and
causing each display associated with a respective user to visually output only data and information pertaining to the hand of that respective user, such that information pertaining the first card and the second card is displayed in a manner that is indistinguishable as to which of the first card and the second card is shared amongst the plurality of users.

11. The non-transitory, machine-readable medium, as claimed in claim 10, wherein the plurality of cards further comprises a third card, a fourth card, and a fifth card, wherein:
two cards selected from the third, fourth, and fifth cards are shared among the plurality of users;
one card selected from the third card, the fourth card, and fifth card is unique to each respective user; and
the display of each user interface system visually outputs only data and information pertaining to an updated hand of the respective user, suppressing information indicating which cards are shared amongst the plurality of users and which card is unique to each respective user.

12. The non-transitory, machine-readable medium, as claimed in claim 10, wherein the at least one wager further comprises a second wager, wherein:
in response to receiving the second wager from a given user, the at least one computing device further performs:
outputting, via the display associated with the given user, an indication that the respective user is eligible to continue to provide inputs to the computing device; and
combining the second wager with the community wager pool.

13. The non-transitory, machine-readable medium, as claimed in claim 12, wherein following the receipt of the second wager, the at least one computing device further performs operations comprising:
ceasing to accept further input from any user from whom the second wager is not received until a future iteration of the card game.

14. The non-transitory, machine-readable medium of claim 10, wherein the operations further comprise:
shuffling the deck comprising the plurality of cards according to the predetermined set of rules prior to distributing the first card and the second card;
evaluating each hand associated with each respective user based on attributes of the cards in the hand and the predetermined set of rules; and
determining an outcome associated with each respective hand.

15. The non-transitory, machine-readable medium of claim 10, wherein the operations further comprise:
establishing, via a communication module, a game session between a server and a plurality of user interface systems respectively associated with the plurality of users.

16. The non-transitory, machine-readable medium of claim 10, wherein the operations further comprise:
retrieving the predetermined set of rules from a memory storage device.

17. A card game method for facilitating game play via a computing device, the method comprising:
maintaining, in at least one memory, a predetermined set of rules for the card game, a deck comprising a plurality of cards, a plurality of hands, and a community wager pool;
presenting, via a respective display of each user interface system associated with the plurality of users, a current state of the card game;
in a first wagering round, receiving from at least some of the plurality of users a first wager each having a value greater than or equal to zero, combining the first wagers into the community wager pool, and restricting further input related to the card game from any user who did not place the first wager;
distributing, from the deck, to each of the plurality of users an initial hand comprising a first card and a second card, wherein the first card assigned to each of the plurality of users has equivalent attributes and the second card assigned to each of the plurality of users is unique to that respective user;
for each respective user, causing the corresponding display to visually output only data pertaining to that user's initial hand, without outputting information indicating whether the first card or the second card is shared among the plurality of users;
in at least one subsequent wagering round, receiving additional wagers from users permitted to continue, combining the additional wagers with the community wager pool, and restricting further input related to the card game from any user who does not place a wager in that wagering round;
distributing, from the deck, to each of the plurality of users additional cards comprising a third card, a fourth card, and a fifth card to form an updated hand for each respective user, wherein two of the third, fourth, and fifth cards are shared among the plurality of users and one of the third, fourth, and fifth cards is unique to each respective user;
for each respective user, causing the corresponding display to visually output only data pertaining to that user's updated hand, without outputting information indicating which of the third, fourth, and fifth cards are shared and which is unique; and
dealing a turn card by selecting a card from the deck, displaying the turn card on a virtual table, and causing the turn card to be visually output on each display as a shared card.

18. The card game method of claim 17, further comprising:
shuffling the deck comprising the plurality of cards according to the predetermined set of rules prior to distributing the first card and the second card;
evaluating, by at least one processing unit, each hand associated with each respective user based on attributes of the cards in the hand and the predetermined set of rules; and
determining at least one outcome of the card game, including at least one of: a winning hand, a losing hand, and a push outcome, based on the evaluation.

19. The card game method of claim 18, further comprising:
disabling, for the given user, one or more input options associated with submitting additional wagers or game decisions during a current iteration of the method; and
maintaining display of a game state associated with the given user without permitting the given user to affect subsequent game actions until the future iteration of the method satisfies at least one re-entry condition defined by the predetermined set of rules.

20. The card game method of claim 17, further comprising:
storing, in at least one volatile memory of a server, a game state record for the card game, the game state record comprising, for each user of the plurality of users, a user identifier, a hand identifier, and card attribute data for cards assigned to that user;
storing, in at least one non-volatile memory, historical records comprising at least one of prior game state records, wager histories, and outcome data;
for each update to the card game, atomically updating the game state record in the volatile memory to reflect at least one of: cards distributed, wagers received, and eligibility of users to continue;
generating, for each user interface system, a user-specific display payload by filtering the game state record to include only the card attribute data and wager information associated with that user; and
transmitting, over a network connection, the corresponding user-specific display payload to each respective user interface system, such that card attribute data for cards shared among the plurality of users is represented in each payload without disclosing, in the payload, an indication of which cards in a given hand are shared and which cards are unique, thereby reducing inter-user information leakage while maintaining synchronized game state across the plurality of user interface systems.
